(19) United States
(12) Patent Application Publication
(10) Pub. No.: US 2010/0143859 A1
(43) Pub. Date: Jun. 10, 2010

(54) Face-Bow

(75) Inventors: Hans Walter Lang, Leutkirch (DE); Alfred Straka, Isny (DE)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: KALTENBACH & VOIGT GMBH, BIBERACH (DE)

(21) Appl. No.: 12/531,233

(22) PCT Filed: Mar. 13, 2008
(86) PCT No.: PCT/EP08/02029

§ 371 Date: Nov. 30, 2009

(30) Foreign Application Priority Data
Mar. 19, 2007 (DE) 10 2007 013 068.8

(51) Int. Cl. A61C 19/045

(52) U.S. Cl. 433/73

(57) ABSTRACT

A dental face-bow comprising a base part, two side arms that extend from the base part and two positioning elements, for example ear pieces for positioning the face-bow on the head of the patient. The positioning elements are situated on the side arms and can be displaced in relation to the side arms. The face-bow is also provided with a displacement device which is used to simultaneously displace the two positioning elements in relation to the side arms. To drive the positioning elements, a dial, which is situated on the base part, can be used for example to turn a flexible shaft that is rotatably mounted inside the two side arms. the two ends of the shaft are equipped with gears that co-operate with gear rods on the positioning elements. This arrangement permits the face-bow to be placed on a patient extremely gently, as there is in particular no relative displacement of the side arms. The face-bow is also provided with a nose support, which can not only be displaced in the longitudinal direction in relation to the base part, but can also be pivoted about a horizontal axis that runs laterally. The face-bow can thus be aligned in a particularly accurate manner with the infra-orbital point in accordance with the shape and size of each patient's head.

The invention relates to a dental face-bow comprising a base part and two side arms that extend from the base part and also two positioning elements for positioning the face-bow on the head of a patient, whereupon the positioning elements are situated on the side arms and can be displaced in relation to the side arms. The invention also relates to a face-bow with a base part and two side arms that extend from the base part and a nose support for positioning the face-bow on the head of a patient.

In dental practice a face-bow is used to record the location of upper jaw rows of teeth in relation to the jaw joints. This location information is typically further used to position an upper jaw model in an articulator as true to life as possible with respect to the jaw joint situation.

To record the location of the upper jaw rows of teeth, the face-bow can be combined with a bite fork, in which impressions of the upper jaw teeth can be created in wax or hard silicone. The bite fork with the impressions of the teeth can then be used by a dental technician for casting the upper jaw model in the correct position in the articulator.

Typically, a reference plane is assumed for transferring the location information. To this end this plane is generally either the so-called “Frankfurt horizontal” (FH), determined by the connecting line between the upper edge of the porus acusticus externus (porion, the highest point of the osseous auditory canal) and the deepest point of the lower edge of the eye socket (orbitals, also called “infra-orbital point” in the following), or the so-called “Camper plane” (CP), determined by the spina nasalis anterior (nasal spine, at the lower end of the osseous nasal opening) and the upper edge of the auditory canal (tragion).

A dental face-bow is, for example, known from the German patent application DE 42 11 016 A1. This face-bow features a base part which is situated centrally in front of the nasal area of a patient, with respect to the right and left halves of the head, when the face-bow is attached to the head of the patient. Extending from the base part are two side arms, which initially extend to the sides and then in each case after curving sideways, run backwards to the ear regions. To clarify the description of the face-bow, the directions used in the following are those that arise when the face-bow is attached to the head of a patient.

To accurately position the face-bow on the head of a patient it is common to use various methods. The face-bow known from DE 42 11 016 A1 to this end comprises two “ear pieces” amongst other features, which are provided for placing in the external auditory canals of the head of the patient. The ear pieces are situated on the two side arms of the face-bow.

To be able to adjust the ear pieces to cater for the varying widths of patients' heads, the two side arms can be displaced sideways. To this end, the two side arms are situated one above the other in the area of the base part and can be displaced sideways. The sideways displaceability is coupled via a counter rotation gear situated on the base part, so that when adjusting different distances of the two ear pieces, the base part can always be kept, i.e. In the centre, in the median sagittal plane. The bite fork can be fixed to the base part so that the bite fork can also always be kept centrally if the side arms are displaced sideways.

An articulator typically has a certain fixed width which is restricted by the design. For this reason the bite fork should be able to be fixed in a central position, i.e. symmetrically to the median sagittal plane with regard to the articulator. For the known face-bow described, this can be achieved by using the specified counter rotation gear.

In the handling of the specified face-bow it is inevitable that the two side arms have to be moved in relation to each other in the direct field of vision of the patient. This can have a negative effect on the patient. In particular, from experience this amounts to the fact that patients perceive the face-bow in the non-fixed condition as “unsound”. Correspondingly, the guide elements, which for the fitting and adjusting of the face-bow are situated directly in front of the eyes of the patient, are also frequently regarded critically by the practitioners, for example, by the dentists treating the patients.

To make matters worse, it can lead to reverse closing movements in the case of undefined friction ratios, for example in the case of dry operation, which frighten the patients or which are even linked to a risk of injury to the patients.

As further positioning elements of the face-bow, which is known from DE 42 11 016 A1, elements are used which include a glabella or nose support and a reference indicator for the infra-orbital point. These two positioning elements are situated on the base part in such a way that they can be displaced in each case according to the length.

The nose support is provided for fitting to the head of the patient on the upper bridge of the nose. For a face-bow that is correctly fitted the reference indicator for the infra-orbital point should then be aligned as accurately as possible with the infra-orbital point so that the face-bow is “aligned with the infra-orbital point”.

To this end, the reference indicator is situated in such a manner on the base part that it lies for average anatomical ratios in the plane of the Frankfurt horizontal, when the ear pieces and the nose support are fitted as intended. In individual cases, the proportions can, however, deviate to a greater or lesser extent from the mean anatomical ratios. For example, between two heads of almost identical size, the vertical distance between the contact surface of the nose support and the infra-orbital point can vary. Since for the named face-bow the alignment of the nose support is linked via the base part with the alignment of the reference indicator, this can consequently cause the face-bow to only be fitted in such a way that it deviates to a greater or lesser extent from the intended, ideal position. In particular it can also result in the fact that after positioning the face-bow using the two ear pieces and the nose support, the reference indicator indicates a point which lies above or below the infra-orbital point.

It also needs to be considered that the ratios, in particular of the vertical distance between the contact surface of the nose support and the infra-orbital point, depend in general also on the size of the head, whereas the angle between the longitudinal extension of the nose support and that of the reference indicator are permanently predetermined and are fixed. For this reason it can lead, for example, in the case of a head that is of larger than average size, to the fact that after fitting the face-bow the reference indicator is aligned to a point above the infra-orbital point. Accordingly, it applies the other way round, for heads which are of smaller than average size.

In this connection, it needs to be considered that it is of considerable importance in view of dental tasks to record the position of the upper jaw in relation to the jaw joints as precisely as possible on the basis of the high level of complexity of the joint ratios.

The object that forms the basis of the present invention is to specify a face-bow which can be fitted in a manner that is more pleasant for patients. As part of this the face-bow should be suitable for different shapes and sizes of heads and easy to handle.

This object is achieved according to the invention by the subject matters specified in the independent claims. Preferred embodiments of the invention are given in the dependent claims.

According to the invention a dental face-bow is provided comprising a base part, two side arms that extend from the base part and two positioning elements to position the face-bow on the head of a patient. The positioning elements are thereby situated on the side arms and can be displaced in relation to the side arms. The face-bow also comprises a displacement device with which the two positioning elements can be moved simultaneously in relation to the side arms. The positioning elements can comprise ear pieces in particular.

As a result of the fact that the two positioning elements can be moved simultaneously with the displacement device in relation to the side arms, the face-bow can be fitted and adjusted without the side arms being moved in relation to each other. It is therefore possible to fit the face-bow in such a way that the patient does not perceive any movement of the side arms, in particular no movement of the side arms directed towards the medial. A very “sensitive” fitting of the face-bow is therefore possible. There are no guide elements for the side arms located in the direct field of vision of the patient.

Moreover, the face-bow can be designed in the area of the base part with smooth surfaces, which is advantageous in terms of cleaning, in particular the disinfection of the face-bow.

As a result of the fact that a movement of the face-bow to adjust the width takes place exclusively in the two ear areas, the face-bow is additionally suited for use as a “head part” as part of an electronic registration system to record jaw joint movements. For such a system, sensors are used, for example based on ultrasound, with whose help the relative movements between the lower and upper jaw can be recorded. To this end the sensors, which are positioned in a fixed location with regard to the upper jaw, are fixed to the “rigid” side arms of the face-bow so that these sensors do not move in relation to each other. The face-bow according to the invention can therefore be used for two types of measurement tasks, “articulator” and “electronic registration system”.

Advantageously, the face-bow comprises a control element with which the displacement device can be moved in such a way that the two positioning elements are moved as a result. This is favorable in view of easy handling, since both positioning elements can be moved simultaneously with only one activation of the control element. For example, the control element can be situated in a central area on the base part, for example almost symmetrically to the median sagittal plane, so that one activation of the control element is possible without one-sided laterally directed forces resulting from this process acting on the face-bow. The face-bow can, in this case, when adjusting the two positioning elements be steadied particularly easily as regards the patient's head.

Advantageously, the displacement device comprises a flexible shaft which, by way of advantage, is at least partially mounted within the two side arms. In this way the movement can be transferred from the control element to the positioning elements without a movement being visible to the patient. At the same time this option is comparatively simple to implement as regards manufacture. The side arms can, for example, be constructed as curved aluminum tubes. These also contribute to minimizing the weight of the face-bow.

At the same time it is further advantageous if the flexible shaft comprises gears at both ends, which act together, for example cog with gear rods, which are situated on the positioning elements. This is a simple and elegant option as regards manufacture of the intended transfer of movement or force.

The control element can, for example, comprise a dial with which the flexible shaft can be rotated. For example, the dial can be simply designed as a section within the shaft so that upon activation of the dial, direct propulsion of the shaft is effected.

The face-bow also advantageously comprises a displaceable nose support, which is mounted with regard to the base part so that it can rotate about a horizontal axis. As a result of this type of mounting it is possible to displace the front area of the face-bow in a certain range of heights. In this way, the face-bow fitted on the patient can therefore be pivoted a little in the adjustment process, in which the axis of rotation runs through the ear pieces. As a result of this the face-bow can be adjusted particularly well for different sized and different shaped heads of patients. In particular, a particularly good alignment of the face-bow with the infra-orbital point is possible.

The nose support is thereby also advantageously mounted and can be displaced longitudinally with regard to the base part. It is particularly favorable in terms of a simple adjustability if a clamping device is provided with which the nose support can be clamped to the base part. It is thereby advantageous if the nose support can be clamped using the clamping device both in terms of its movement about the horizontal axis and in terms of its movement in the longitudinal direction. As a result of this, only one work step is necessary to determine or fix the position of the nose support with respect to the base part.

In accordance with a further aspect of the invention, a dental face-bow is provided comprising a base part and two side arms that extend from the base part and also a nose support to position the face-bow on the head of a patient. The face-bow further comprises a mounting element for the nose support, in which the mounting element makes it possible for the nose support to move in rotation in relation to the base part about a horizontal axis. The mounting element can thereby advantageously be designed as part of a fixing and releasing device for the nose support. For example, a clamping device can be provided for this purpose.

The invention is explained in more detail hereinunder with reference to an exemplified embodiment and with regard to the diagrams, in which

FIG. 1 shows a front view of a face-bow according to the invention,

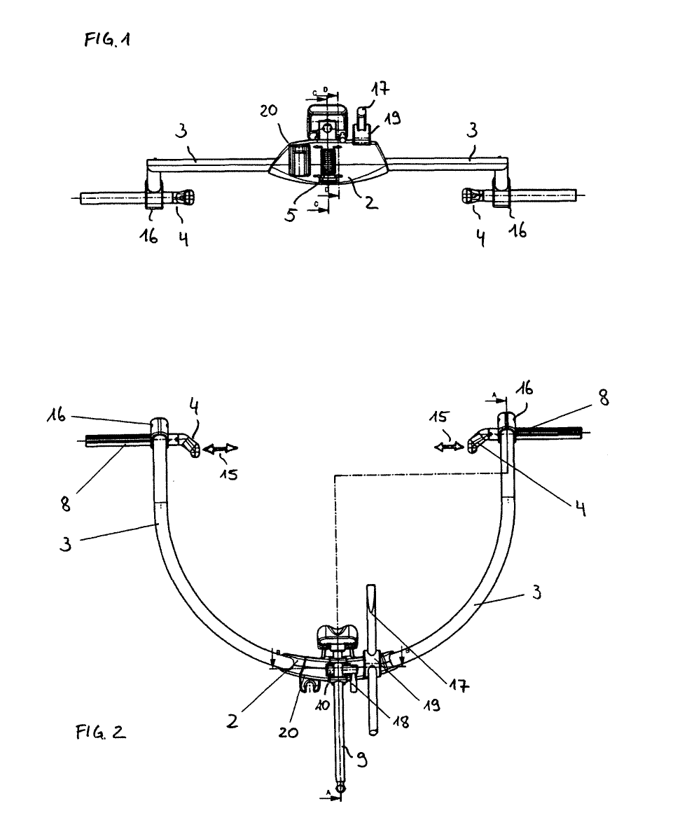

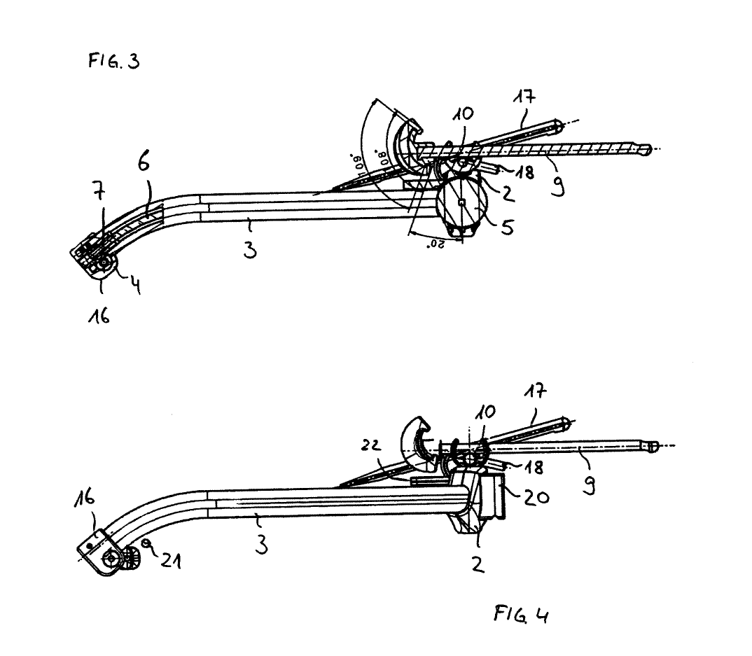

FIG. 2 shows a view from above of the face-bow,

FIG. 3 shows a cross-section along the section A-A from FIG. 2,

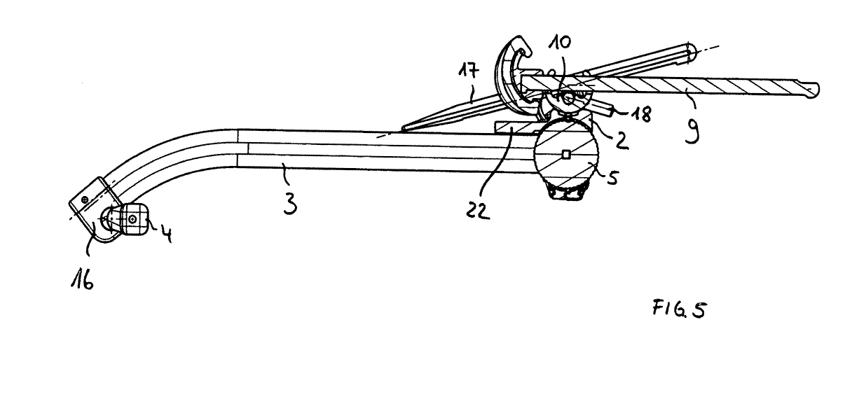

FIG. 4 shows a side view of the face-bow,

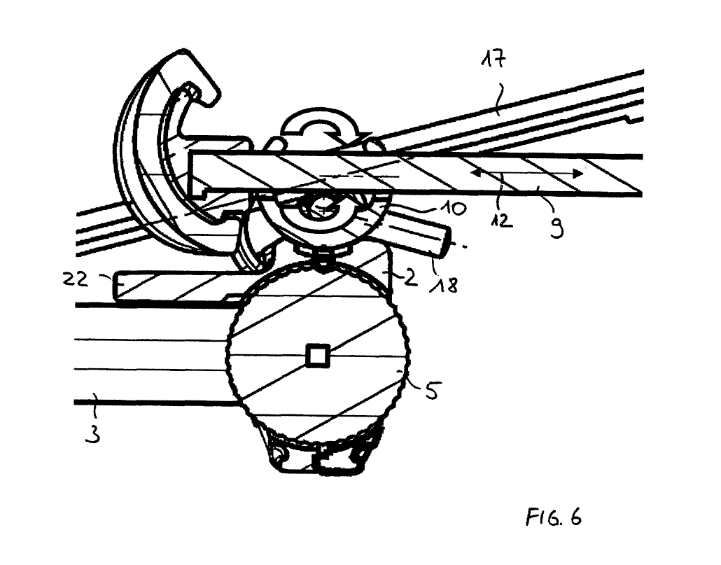

FIG. 5 shows a cross-section representation of the face-bow, and

FIG. 6 shows a section from FIG. 5 around the area of the base part.

An exemplified embodiment of a dental face-bow according to the invention is represented in the figures. As elements of the face-bow a base part 2 is identified, as well as a right and a left side arm 3. The side arms 3 thereby extend from the base part 2 and extend initially in each case a little laterally, following by a curve directed towards the rear and finally extending in a posterior direction. When the face-bow is fitted to a patient, the two side arms 3 each extend until they reach an area outside of the field of vision of the patient, namely sideways from the patient's ears.

For the exemplified embodiment the side arms 3 are fixedly attached to the base part 2. They can, for example, be fixed firmly to the base part 2. In the exemplified embodiment both the base part 2 and the side arms 3 are formed from a non-transparent and non-translucent material, i.e. from an opaque material. Additionally, the base part 2 and the side arms 3 are so rigid in themselves that a displacement of the side arms 3 as part of the intended handling of the face-bow is virtually invisible under normal exertion of force.

A right and a left positioning element are also identified in the form of ear piece elements or ear pieces 4, for short. These are provided for the purpose of being inserted a little in the two external auditory canals of the patient so that they are used to position the face-bow on the head of the patient. To this end the ear pieces 4 are situated on the side arms 3 and can be displaced in relation to the side arms 3. The ear pieces 4 can thereby be displaced in a sideways, or lateral, direction as is indicated by the two double arrows 15 in FIG. 2. To this end, a mounting part 16 is used in each case, which is firmly situated on the respective side arm 3, namely in the respective end area of the corresponding side arm 3. The ear pieces 4 are thus mounted in the mounting parts 16 and can be displaced laterally with regard to the respective side arm 3.

Since in the exemplified embodiment the mounting pieces 16 are fixedly attached to the side arms 3, the ear pieces 4 are situated in the respective sagittal plane or in the anterior/posterior direction 3 in a non-displaceable manner on the side arms.

The ear pieces 4 are situated on the side arms 3 in an area that lies outside of the field of vision of the patient. This has the advantage that when fitting the face-bow the side arms 3 can be steadied in relation to the head of the patient so that the patient does not perceive any movement of the face-bow when the ear pieces 4 are moved in the auditory canals of the ears. In particular the side arms 3 do not thereby move towards each other, which would represent a potentially unpleasant movement for the patients.

To move or to drive the ear pieces 4 a displacement device is provided with which the two ear pieces 4 can be simultaneously moved in relation to the side arms 3. The displacement device comprises a flexible shaft 6, which can be partially identified in the sectional view of FIG. 3. The flexible shaft 6 runs within the side arms 3 and through the base part 2. The side arms 3 are designed as tubes for this purpose and in this way form a protective tube for the flexible shaft 6. For example, the side arms 3 can be designed as aluminum tubes for this purpose.

The shaft 6 extends within the side arms 3 up to the areas of the two mountings 16 on which the ear pieces 4 are situated. At these two points the shaft 6 is designed in each case as gear 7 or accordingly connected so that they cannot rotate to a gear. In the side arms 3, openings for the gears 7 are formed in the area of the mounting parts 16. In the area of the face-bow, which lies within the field of vision of the patient, the side arms 3 do not comprise any openings so that the movements of the shaft 6 within the side arms 3 are not visible to the patients.

The two ear pieces 4 comprise gear rods 8, which act together with the gears 7 of the shaft 6, for example, to cog into this. In a rotation of the shaft 6 in a first direction of rotation the two ear pieces 4 move towards each other so that the distance between them is decreased. When moving the shaft 6 in the opposite second direction of rotation the ear pieces 4 move away from each other so that the distance between them is increased.

To move the shaft 6, a control element is provided in the form of a drive wheel or dial 5, which in the exemplified embodiment, as for example seen from FIG. 1, is attached in the base part 2, namely centrally, i.e. symmetrically to the median sagittal plane and is mounted so that it can be rotated. The dial 5 is connected to the shaft 6 so that is cannot be rotated, so that by rotating the dial 5, a torque is directly transferred to the shaft 6 and further, via the gears 7 and the gear rods 8, the ear pieces 4 are moved.

As best seen from FIG. 1, in the base part 2, an anterior or forwards-looking window is formed through which the dial 5 partially protrudes so that it can be operated by a finger in both directions of rotation.

On the side of the base part 2 that points towards the face of the patient, i.e. on the posterior or reverse surface, no opening is provided in the base part 2, so that a movement of the shaft 6 is also not visible to the patients at this point.

After adjusting the position of the ear pieces 4 it is not necessary based on the mechanical ratios of the displacement device, in particular based on the engagement of the gears 7 in the toothed cog 8, for the position of the ear pieces 4 to be secured, or clamped. A work step in this regard can be omitted. In particular no screwing or similar movement is necessary on the face-bow which would have a potential negative impact on the patient.

As a result of the fact that the two side arms 3 are connected in a non-movable manner to the base part 2, the surfaces of the face-bow in the area of these connections can be designed to be smooth. This is advantageous because in this way it is possible for cleaning, in particular disinfection, of the face-bow in this area to be particularly easy.

The face-bow in the exemplified embodiment also comprises a long glabella support or nose support 9 which is provided for fitting on the upper bridge of the nose of the patient, i.e. in the area of the skin nasion. This is attached so that it can be displaced with regard to the base part 2, namely in such a way that the longitudinal axis of the longitudinal shaft of the nose support 9 lies within the median sagittal plane. In the exemplified embodiment a mounting element situated on the base part 2 is provided for the nose support 9 for this purpose, in which the nose support 9 is mounted so that it is displaceable longitudinally and also so that it can be pivoted about a horizontal axis which runs in a frontal plane, or normal to the median sagittal plane. In FIG. 6 the longitudinal displaceability of the nose support is indicated with a double arrow 12.

In the exemplified embodiment the mounting element for the nose support 9 is designed as part of a fixing and releasing device in the form of a clamping eccentric device or, in short, a clamping eccentric 10 for the nose support 9. This device is situated centrally, i.e. in an area around the median sagittal plane, on the base part 2. Using the clamping eccentric 10 it is possible to clamp the nose support 9 in a set position with regard to the base part 2. To this end the clamping eccentric 10 comprises an operating element in the form of a locking lever 18 with which the nose support 9 can be clamped both in terms of its longitudinal movement and also its pivoting mobility. This facilitates a particularly easy adjustment of the nose support with regard to the base part 2. As a result of the central situation, adjustment or clamping is also possible in this connection without appreciable lateral forces acting on the face-bow.

The movement of the clamping eccentric 10 in the clamping procedure is indicated in FIG. 6 with two semi-circular arrows.

To be able to record the location of the upper jaw as precisely as possible the face-bow should be aligned with the infra-orbital point of the patient. To this end a reference indicator, or indicator for short, 17 is situated on the face-bow, which is provided for indicating one of the two infra-orbital points upon correct positioning of the face-bow. The indicator 17 can thereby be situated on the base part 2, so that it can be displaced, by means of an appropriate bracket 19, for example shown in FIG. 2.

Depending on the size and shape of the head of the patient, the location of the infra-orbital point varies with regard to the two external auditory canals and the installation point of the nose support 9. It is therefore generally necessary when fitting the face-bow for the direction of the reference indicator to be adjusted accordingly to the anatomical ratios which exist in individual cases.

For this purpose the embodiment described above of the mounting of the nose support 9 to the base part 2 is advantageous. As a result of the option of pivoting the nose support 9 about the horizontal in a frontal plane, i.e. sideways or crossways running axis, the base part 2 can be moved and fixed compared with the head of the patient within a certain height range in different heights. In this way the direction of the reference indicator 17 can be changed and excellently adjusted to the given ratios in each case.

If the clamping eccentric device 10 is loosened, the nose support 9 can be moved forwards and backwards in a bore hole situated on this device. The face-bow can therefore be adjusted to a certain head size. At the same time the nose support 9 can be pivoted in the clamping eccentric device 10 by means of the mounting element, so that the reference indicator 17 can be aligned with the infra-orbital point. Alignment of the face-bow with the infra-orbital point can hereby be effected.

When fitting, the following procedure can be used, for example: initially with one hand the face-bow is put into position with regard to the head of the patient, which roughly corresponds to the intended position. The dial 5 is then activated with the second hand so that the ear pieces 4 move towards each other until they engage in the external auditory canals of the head of the patient. Finally—with the clamping eccentric 10 open—the base part 2 is positioned by pivoting the face-bow in height about a rotational axis running through the ear pieces 4 in such a way that the reference indicator 17 points towards one of the two infra-orbital points. (In this setting the indicator 17 runs at least approximately in the plane of the Frankfurt horizontal). Whilst retaining this position the nose support 9 is then moved in such a way that its contact surface rests on the point provided for this purpose on the upper bridge of the nose and is then brought to its fixed position by activating the locking lever 18 of the clamping eccentric 10.

As further shown in the figures, a bracket 20 is provided on the face-bow in accordance with the exemplified embodiment for a bite fork (not illustrated in the figures).

Furthermore in FIG. 4 the location of the axis of rotation 21 is marked, which gives the location of the hinge axis of the jaw joint in the area near occlusion for mean anatomical ratios.

In FIGS. 3 to 6 an attachment plate 22 is also identified, which is used to position the face-bow in an articulator (not illustrated in the figures).

The face-bow according to the invention is also suited for use as a “head part” for an electronic registration system to record jaw joint movements. For such a system, sensors are used with whose help the relative movements between the lower and upper jaw can be recorded. To this end, the sensors, which are positioned “fixed” with regard to the upper jaw, can be fixed to the “rigid” side arms of the face-bow so that these sensors do not move in relation to each other.

The face-bow according to this invention can be fitted quickly and thereby easily. Movements of the face-bow, which are potentially unpleasant for the patient, can thereby be avoided. The face-bow is also suited for the purpose of being used as a head part of an electronic registration system. The face-bow is therefore also advantageous from a commercial perspective.

### LIST OF REFERENCES

2 Base part
3 Side arms
4 Positioning elements, ear pieces
5 Control element, dial
6 Flexible shaft
7 Gears
8 Gear rods
9 Nose support
10 Clamping device for nose support, clamping eccentric
11 Central element
12 Longitudinal displacement ability of the nose support
15 Movement direction of the ear pieces
16 Mounting parts for the ear pieces
17 Indicator for the infra-orbital point
18 Locking level of the clamping eccentric
19 Bracket for the reference indicator
20 Bracket for a bite fork
21 Axis of rotation of the jaw joint
22 Attachment plate

1.-10. (canceled)

11. A dental face-bow comprising
a base part,
two side arms extending from the base part,
two positioning elements to position the face-bow on the head of a patient, in which the positioning elements are attached to the side arms and can be displaced in relation to the side arms, and
a displacement device with which the two positioning elements can be simultaneously moved in relation to the side arms.

12. A face-bow of claim 11 comprising a control element, with which the displacement device can be moved in such a way that the two positioning elements are moved as a result.

13. A face-bow of claim 11, wherein the displacement device comprises a flexible shaft.

14. A face-bow of claim 13, wherein the flexible shaft is mounted at least partially within the side arms.

15. A face-bow of claim 13, wherein the flexible shaft has two ends and comprises gears at both of the ends, which act together with gear rods, which are situated on the positioning elements.

16. A face-bow of claim 13, comprising a dial, with which the flexible shaft can be rotated.

17. A face-bow of claim 11, additionally comprising a displaceable nose support mounted with respect to the base part so that it can be rotated about a horizontal axis.

18. A face-bow of claim 17, wherein the nose support is mounted so that it can be displaced longitudinally with respect to the base part.

19. A face-bow of claim 17 comprising a clamping device, with which the nose support can be clamped with respect to the base part.

20. A face-bow of claim 19, wherein the nose support can be clamped with the clamping device with respect to the base part both with respect to longitudinal displacement and with respect to rotational movement.

21. A dental face-bow, comprising,
a base part,
two side arms extending from the base part,
a nose support for positioning the face-bow on the head of a patient, and
a mounting element for the nose support, wherein the mounting element facilitates rotational movement of the nose support with respect to the base part about a horizontal axis.

22. A face-bow of claim 21, wherein the mounting element is part of a fixing and releasing device for the nose support.

23. A face-bow of claim 22, wherein the mounting element is part of a clamping device for the nose support.
